(19) United States
(12) Patent Application Publication
(10) Pub. No.: US 2005/0187850 A1
(43) Pub. Date: Aug. 25, 2005

(54) Method for efficient investment and distribution of assets

(76) Inventors: Stuart Horowitz, Coral Springs, FL (US); Andrew Rosenberg, Weston, FL (US)

Correspondence Address: LERNER AND GREENBERG, PA, P O BOX 2480, HOLLYWOOD, FL, 33022-2480, US

(21) Appl. No.: 10/787,495

(22) Filed: Feb. 25, 2004

(51) Int. Cl. G06F 17/60

(52) U.S. Cl. 705/36; 705/35

(57) ABSTRACT

A portfolio is invested into a multiplicity of investments pool each having different assumed average rates of return. A first pool has an assumed average first rate of return that is the lowest rate of return of all the pools. Distributions are first withdrawn from the first pool, as desired, before withdrawing funds from any of the other pools. At least part of the assets of a second pool which has an assumed second rate of return being the next lowest rate of return are converted into a new pool when the first pool is exhausted. The assets of the new pool are invested in investments having the same assumed average rate of return as the first pool. Therefore, one of the investment pools is designated to have funds withdrawn from it and the other investment pools can be invested for potentially higher rates of return and more tax efficiently.

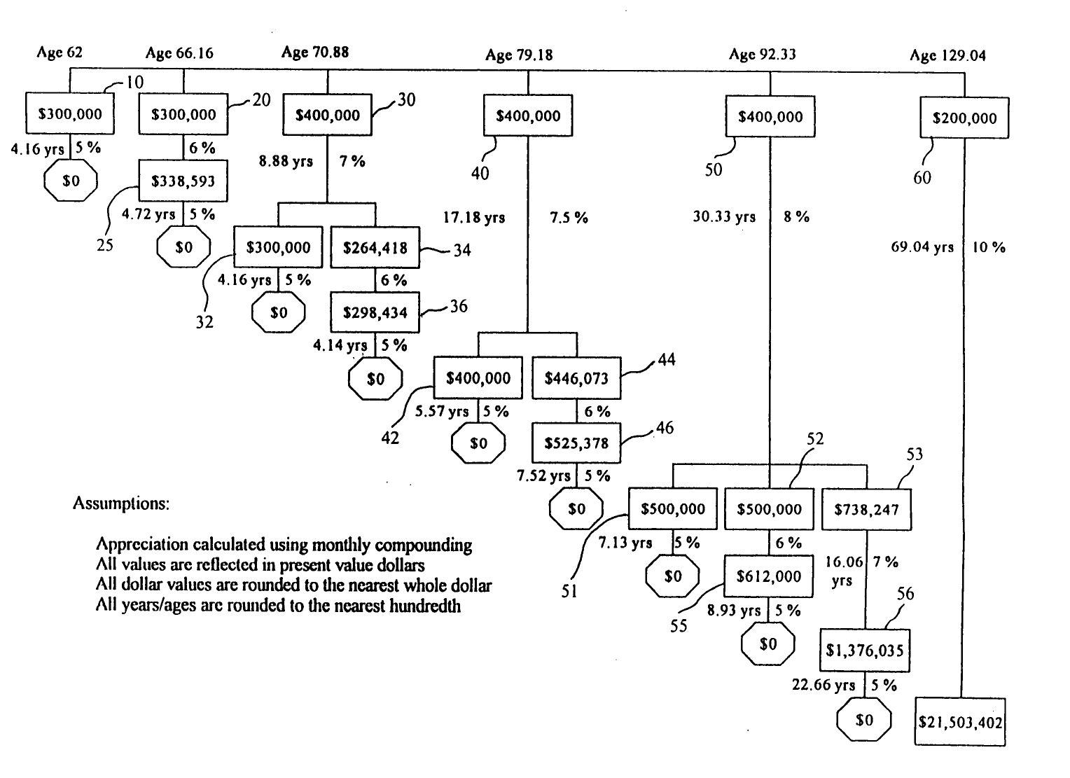

### BACKGROUND OF THE INVENTION

1. Field of the Invention

The invention relates to a method for investing money in a tax-efficient and risk efficient manner and for supporting and distributing a desired current and future tax efficient income stream.

2. Description of the Related Art

Many different money management strategies exist all having varying degrees of risk and return. There are a number of different ways of thinking about and characterizing risk and return. Firstly, short-term, high credit quality vehicles are generally low risk because the investment principal is relatively safe, the investment will fluctuate little if at all relative to the market or interest rates, and the assets of the investment are generally more liquid. Examples of short-term vehicles abound ranging from passport savings accounts, certificates of deposit, money market accounts, and short-term government and investment grade corporate bonds, to name a few. In this range of investments, the rate of return is generally low, due to the minimal level of risk assumed.

Medium and long-term investments generally have additional firm specific, market and/or liquidity risks. With such higher levels of risk, investors demand higher rates of return. Investors increasingly understand the potential for higher long-term returns from investments in higher risk assets. Historically investments in equities provide on average and over the long-term a higher return than short-term bond instruments. However, such investments carry higher risks with no guarantee of return. Consequently, ever since investments were created, efforts have been made to reduce risks associated with investing.

A vast number of products, services and techniques have been developed in attempts to reduce or avoid risk. An example of such a technique is hedging which includes buying put options on an index to hedge against decreases in value in a portfolio that reasonably matches the index.

U.S. Pat. No. 6,360,210 to Wallman teaches a computer based method and system that reduces market risk for a specified portfolio, by examining the expected portfolio risk, pricing the expected risk, and transferring the expected risk or related market risk in exchange for consideration which can be in the form of cash, other property, or future returns. A user enters information about his/her portfolio into a computer system and a desired level of downside risk. The portfolio is then analyzed to determine the price to charge the user. The computer-based system then provides a series of choices to the user. The user selects the time periods for which he seeks shielding from the market risk of the portfolio and a degree of risk. The computer-based system then prices the requested shielding in a variety of different manners. However, in the end, the user has no real understanding of his overall investment strategy but is offered risk protection for a given price.

U.S. Patent Publication 2003/0233301 A1 to Chen et al. also teaches another method, system and medium for optimally allocating investment assets for a given investor within and between annuitized assets and non-annuitized assets. Once again, an extremely complicated investment strategy is put further which may be effective but is generally not comprehended by the average investor.

As individuals become more involved in their own investment process, there is a need for an effective, tax efficient and easy to comprehend investment strategy in which the investor feels secure in the overall investment philosophy.

### SUMMARY OF THE INVENTION

It is accordingly an object of the invention to provide a method for investing money in a tax-efficient and risk efficient manner and for supporting and distributing a desired current and future tax-efficient income stream, which overcomes the herein-mentioned disadvantages of the heretofore-known methods of this general type, which is easy to understand and implement.

With the foregoing and other objects in view there is provided, in accordance with the invention, a method for allocating assets of a portfolio. The method includes the steps of investing a first portion of the assets in a first investment pool at an assumed average first rate of return, investing a second portion of the assets in a second investment pool at an assumed average second rate of return being greater than the assumed average first rate of return, investing a third portion of the assets in a third investment pool at an assumed average third rate of return being greater than the assumed average second rate of return, and converting assets of the second investment pool into a fourth investment pool having the assumed average first rate of return when the first investment pool is exhausted.

Because the first investment pool is setup to generate income and is available for handling distributions, the remaining funds can avail themselves of investments positioned for a longer time period having a higher rate of return and at the same time be tax sheltered. Therefore, one can gain the benefits and assume the risk of higher volatile investments and at the same time be assured a short to medium-term cash flow.

The distributions can occur on a weekly, monthly or annual basis or as desired. Once the first investment pool is exhausted, the second investment pool having a slightly higher level of risk and potential return is converted into investments similar to that of the first investment pool and serves as the pool from which assets are distributed from as needed. In this manner, the investments in the third and higher investment pools may have progressively higher rates of return (i.e. more aggressive investment portfolios). In addition, the third and higher investment pools may be invested in more tax advantageous vehicles.

In accordance with an added mode of the invention, there is the step of distributing assets, being a combination of income and return of principle, from the first investment pool before distributing assets from any other investment pool. Because the distribution is a combination of income and return of principle, tax liabilities are minimized.

In accordance with an additional mode of the invention, there is the step of distributing the assets from the first investment pool on a weekly, monthly or annual basis until the first investment pool is completely exhausted from the distributions of income and return of principle. Of course the distribution period is dependent on the needs of the client.

In accordance with a further mode of the invention, after the assets of the second investment pool have been converted to the fourth investment pool, assets from the fourth investment pool are distributed when the assets of the first investment pool are completely exhausted due to the distributions of income and return of principle.

In accordance with another mode of the invention, there is the step of bifurcating the assets of the third investment pool into a fifth investment pool having the assumed average first rate of return and a sixth investment pool having the assumed average second rate of return when the fourth investment pool is completely exhausted due to the distributions of income and return of principle. Assets are then distributed from the fifth investment pool until the fifth investment pool is exhausted due to the distributions of income and return of principle.

In accordance with another added mode of the invention, there is the step of converting assets of the sixth investment pool into a seventh investment pool, having the assumed average first rate of return, when the fifth investment pool is exhausted due to the distributions of income and return of principle. Assets are then distributed from the seventh investment pool until the seventh investment pool is exhausted due to distributions of income and return of principle.

In accordance with another feature of the invention, a size of the first portion, initially held in the first investment pool, is set to be large enough to handle anticipated distributions of short-term cash flow needs for at least three years. However, this number could easily be four, five, six, seven, etc. years or a fraction thereof.

In accordance with a further feature of the invention, the annual amount of funds needed to be withdrawn per year is designated and then a size of the first portion initially held in the first investment pool is set to be at least three times the annual amount.

In accordance with yet another feature of the invention, the size of the second portion to be initially held in the second investment pool is set to be at least three times the annual amount, and all remaining assets are put in the third or latter investment pools.

In accordance with a further feature of the invention, the value of each of the investment pools is periodically reviewed and a rebalancing of the values of all the investment pools is performed, as needed. Should an investment pool do extremely well or extremely poorly, it may be desirable to move assets in or out of such performing pools, following the investment principle of buying low and selling high.

In accordance with a feature of the invention, the size of the fifth investment pool is set to be at least three times an annual amount to be withdrawn over a course of a year, and all the remaining assets of the third investment pool are put into latter investment pools (e.g. the sixth investment pool).

In accordance with a concomitant feature of the invention, the assets in each subsequent investment pool are invested for a longer time period than a previous investment pool where the assets of the sixth investment pools are invested for a longest time period and the assets of the first investment pool are invested for the shortest period of time.

Other characteristic features of the invention are set forth in the appended claims.

Although the invention is illustrated and described herein as embodied in a method for investing money in a tax-efficient and risk efficient manner and for supporting and distributing a desired current and future tax-efficient income stream, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a flow chart for illustrating a method of investing and distributing assets according to the invention.

### DESCRIPTION OF THE PREFERRED EMBODIMENTS

Referring now to the single FIGURE of the drawings in detail, there is shown a flow chart for describing an investment and distribution method according to the invention. One of the unique features of the investment method is that it provides short-term cash flow needs and at the same time avails itself of long-term investments that generally allow for higher rates of return and greater tax efficiency.

The inventive method will be described using the example of a 62 year old client having $2,000,000 to invest in an investment portfolio. The client requires a yearly income of $75,000. Therefore, the portfolio must provide a yearly income of $75,000 in present value dollars.

The $2,000,000 will be invested in six separate investment pools shown by flow paths 10, 20, 30, 40, 50, 60. Each investment pool utilizes investments of different levels of risk and assumed average rates of return. It is noted that six investment pools are shown, but this number can range from two to well over ten different investment pools.

Because the client needs a guaranteed income of $75,000 (in present value dollars) per year, the first investment pool 10 is the most conservative and therefore has the least risk and the lowest assumed growth rate (i.e. 5%) of all the investment pools. The first investment pool 10 is expected to provide $75,000 for the first 4-5 years. Therefore, $300,000 is invested in the first investment pool 10. The first investment pool includes very conservative investments such as certificates of deposits, short-term government bonds, money market funds, and short-term bank loans to name a few. Therefore, the principle investment is relatively secure and a fairly certain return can be anticipated. At the end of the first year $229,369 is available in the first pool after distributing $75,000 and growing at an assumed 5% rate of return. At the end of the second year $157,366 is available after distributing $75,000 and growing at the assumed 5% rate of return. Assets from the first investment pool are used until it is exhausted. It is noted that the figure of the drawing calculates in a 3% inflation rate. Factoring for inflation the first investment pool is emptied within the fifth year and further withdrawals are required from a second source of funds to fulfill the need for the annual distribution of $75,000 (present value). The first investment pool 10 would actually last approximately 4.16 years adjusting for inflation (present value).

Because the first investment pool 10 covers the short-term cash flow needs, the remaining $1,700,000 can be invested more aggressively with less concern for short-term market fluctuations as the funds will be invested for a more extended period of time.

A key element within the distribution of each pool is the inherent tax efficiency. The source of each distribution is a combination of income, which may be taxable, and return of principle, which is generally not taxable, thus minimizing the overall tax to the client.

The second investment pool 20 has initially a slightly more assumed aggressive average rate of return of 6%. This is possible because no funds need to be withdrawn from the second investment pool 20 for at least four years. Therefore, the funds in the second investment pool can be less liquid and therefore invested slightly more aggressively than that of the first investment pool 10. Initially $300,000 is invested in the second investment pool 20 at an assumed average 6% rate of return. At the time the first investment pool 10 is exhausted, funds are withdrawn from the second investment pool 20 to provide the money for the yearly requirement of $75,000 (present value dollars). The second investment pool 20 provides money for the necessary withdrawals in the fifth through tenth year. However, at the point in time in which the first investment pool 10 is exhausted, the funds in the second investment pool 20 are then converted to a lower risk investment pool 25 having an assumed average rate of return of 5%, as in the first investment pool 10, to provide the required stable income stream. The $75,000 distribution is now taken from the lower risk investment pool 25.

A third investment pool 30 is provided and assumes an even higher average rate of return of 7%. Initially, $400,000 is invested in the third investment pool 30. At the time the investment pool 25 has run out of funds to pay the yearly $75,000 disbursement (present value), the third investment pool 30 has a value of $564,418 (adjusted for inflation). When the investment pool 25 is exhausted, the third investment pool 30 is bifurcated and its assets are converted into a distribution pool 32 mirroring the first investment pool having an assumed average 5%. return and a somewhat more aggressive investment pool 34 having an assumed average 6% return on investments mirroring the second investment pool 20. The yearly income distribution is first provided from the pool 32 in which a tax efficient return of principle and taxable income is distributed. At the time pool 32 is exhausted, the assets in investment pool 34 are converted into pool 36 providing an assumed average rate of return of 5%. The yearly $75,000 present value distribution is now provided for from the income and return of principle of pool 36.

During the first 17.18 years a fourth investment pool 40 has its assets invested in even more aggressive investments. Because assets from the fourth investment pool 40 will not be tapped for providing the yearly income for over 17 years, more volatile investments with greater return potential can be had. Initially, $400,000 is invested in the fourth investment pool 40 at an assumed average rate of return of 7.5%. The money is allowed to grow at this assumed average rate until the investment pool 36 is exhausted. At this point the fourth investment pool 40 is bifurcated and the assets are converted into pool 42 having an assumed average rate of return of 5% (i.e. mirroring the first investment pool 10) and another investment pool 44 assuming an average rate of return of 6% (mirroring the second investment pool 20). The annual $75,000 present value distribution is first paid out via income and tax-efficient return of principle from pool 42 until it is exhausted. At this point assets of the investment pool 44 are converted to provide an assumed average rate of return of 5% creating pool 46. The yearly $75,000 present value distribution is now paid out via income and tax-efficient return of principle from pool 46 until it is exhausted.

During the first 30.33 years a fifth investment pool 50 has its assets invested in vehicles with an even greater assumed investment rate of return. Because assets from the fifth pool 50 will not be tapped for providing the yearly income for over 30 years, more volatile investments with greater return potential can be had. Initially $400,000 is invested in the fifth investment pool 50 at an assumed average rate of return of 8%. The assets average the 8% return until the.investment pool 46 is exhausted. At this point, the assets of the fifth investment pool 50 are trifurcated into investment pools 51, 52, 53 having respective assumed average rates of returns of 5%, 6%, and 7%, and asset values (present value) of $500,000, $500,000, and $738,247, respectively.

The investment pool 51 is used to pay the $75,000 yearly present value distribution until it is exhausted. At this point, the assets of investment pool 52 are converted to a lower assumed average rate of return of 5%, creating pool 55. The $75,000 yearly present value distribution is now paid via income and tax-efficient return of principle from pool 55. Because pool 55 is estimated to be able to provide funds for 8.93 years, the assets of investment pool 53 are not converted to more conservative investments at this time. However, when pool 55 is exhausted, the assets of investment pool 53 are converted to investments designed to produce an assumed average rate of return of 5%, creating another distribution pool 56. The $75,000 annual present value distribution is now provided via income and tax-efficient return of principle from pool 56.

It is noted that throughout the application, the pools have been bifurcated and trifurcated. However, one is not limited to two or three new pools and the number of pools is just exemplary. The number of pools and dollar amounts invested in each pool are determined from client needs, age and risk profile to name just a few parameters.

The assets from the last or sixth investment pool 60 are considered a legacy pool. Assets from this pool are invested to generate the highest potential average rate of return (e.g. 10%) and should never have to be tapped for yearly disbursements. $200,000 is initially invested in this pool and the assets are designed for inheritance only, therefore, the terminology legacy pool is used.

The method of investing according to the invention not only allows for more aggressive investing of the assets of pools two through six, but also provides tax advantages. Because the assets will not be used for income generation and distribution, these assets can be invested in more tax efficient vehicles. This is best understood using the example of our 62 year old client. Prevailing investment philosophy dictates that our client should invest his entire portfolio in a relatively safe income-producing portfolio in which the income is taxed on a yearly basis. For example, the typical investment philosophy would dictate that the client invest the whole $2,000,000 dollars in fixed income instruments such as money market funds, certificates of deposits, corporate bonds and treasuries. However, the return on these investments is immediately subject to taxation whether or not the income is needed. The method according to the invention also subjects the returns from the first investment pool to taxation. However, the remaining pools can be invested in more tax friendly investments since no income production is required in the short-term. For example, real estate, where one benefits from asset depreciation, provides a medium for tax-efficient growth.

Please note that six investment pools are shown. However, the investing method works well with two, three, four, five, six, seven, eight, nine, or ten pools. Theoretically, there is no limit to the number of pools.

The rates of return shown are hypothetical in nature. The assumed rates of return will be dependent upon the particular circumstances of the client, prevailing interest and inflation rates, and investment opportunities. However, conservative rates of return may be assumed for extremely conservative clients with excess funds, while more aggressive rates of return may be assumed by risk tolerant clients with potentially limited funds. The client is shown to have an initial age of 62 years old, but this strategy works for a client of any age. As shown by the example, the cash flow is still available after 60 years.

In the method a 3% inflation rate is used. Of course this rate is only exemplary as are the assumed average rates of return. In reality, the inflation rate, interest rates and assumed average rates of return will not be constant, but one can always assume a risk/return relationship.

In general, in the prior art, the older the client the more conservative rates of return are selected for all of his investments. A common self-created investment portfolio for a client age 62 would be invested almost exclusively in conservative investments such as corporate bonds, municipality bonds, government bonds, certificates of deposits and possibly preferred stocks. However, such a portfolio does not avail itself of the greater returns possible by investing in higher risk investments such as equities and real estate, nor does it address the impact of inflation. Because of market fluctuations, it is considered too dangerous for older clients to invest in such aggressive investments. However, the investing method of the invention clearly teaches a tax-efficient and risk efficient method that provides for the relatively certain short-term income needs of the client, through distribution of mostly taxable income and generally nontaxable return of principle, and at the same time provides the benefits of potential greater investment returns through longer term investment periods. In addition, the investment philosophy is designed to be easily understood and is explained to a perspective client using one simple chart such as the flow chart drawing provided herein. Many perspective clients are overwhelmed by the complicated investment strategies offered to them by investment professionals. The value of an easy to understand and at the same time effective and efficient investment method should not be underestimated in the market place.

For illustrative purposes only, the following rates of return and a sample of associated investment classes are provided:

| Rate of Return | Types of Assets |
|---|---|
| 5% | Money Market Funds, Treasuries, |
| | Short-Term Bank Loans, and |
| | Certificate of Deposits |
| 6% | Short & Intermediate-Term Investment |
| | Grade Corporate and Municipality |
| | Bonds |
| 7% | Intermediate-Term Corporate Bonds, |
| | Convertible Bonds, Preferred Stocks |
| 7.5% | Large-Cap Equities, Real Estate |
| 8% | Mid-Cap Equities, High Yield Bonds, |
| | Emerging Market Debt, Global Bonds |
| 10% | Small-Cap and International Equities, |
| | Emerging Market Equities, Managed |
| | Futures, Limited Partnerships, Hedge |
| | Funds |

1. A method for allocating assets of a portfolio, which comprises the steps of:
investing a first portion of the assets in a first investment pool at an assumed average first rate of return;
investing a second portion of the assets in a second investment pool at an assumed average second rate of return being greater than the assumed average first rate of return;
investing a third portion of the assets in a third investment pool at an assumed average third rate of return being greater than the assumed average second rate of return; and
converting assets of the second investment pool into a fourth investment pool having the assumed average first rate of return when the first investment pool is exhausted.

2. The method according to claim 1, which further comprises distributing assets, being a combination of income and return of principle, from the first investment pool before distributing assets from any other investment pool.

3. The method according to claim 2, which further comprises distributing the assets from the first investment pool on a weekly, monthly or annual basis until the first investment pool is completely exhausted from the distributions of income and return of principle.

4. The method according to claim 2, which further comprises:
after the assets of the second investment pool have been converted to the fourth investment pool having lower risks, distributing assets from the fourth investment pool when the assets of the first investment pool are completely exhausted due to the distributions of income and return of principle.

5. The method according to claim 4, which further comprises:
bifurcating assets of the third investment pool into a fifth investment pool having the assumed average first rate of return and a sixth investment pool having the assumed average second rate of return when the fourth investment pool is completely exhausted due to the distributions of income and return of principle; and
distributing assets from the fifth investment pool until the fifth investment pool is exhausted due to the distributions of income and return of principle.

6. The method according to claim 5, which further comprises:
converting assets of the sixth investment pool into a seventh investment pool, having the assumed average first rate of return, when the fifth investment pool is exhausted due to the distributions of income and return of principle; and
distributing assets from the seventh investment pool until the seventh investment pool is exhausted due to distributions of income and return of principle.

7. The method according to claim 1, which further comprises:
setting a size of the first portion, initially held in the first investment pool, to be large enough to handle anticipated distributions of short-term cash flow needs for at least three years.

8. The method according to claim 1, which further comprises:
designating an annual amount of funds needed to be withdrawn per year; and
setting a size of the first portion initially held in the first investment pool to be at least three times the annual amount.

9. The method according to claim 8, which further comprises:
setting a size of the second portion to be initially held in the second investment pool to be at least three times the annual amount; and
putting all remaining assets in the third investment pool.

10. The method according to claim 5, which further comprises:
setting a size of the fifth investment pool to be at least three times an annual amount to be withdrawn over a course of a year; and
putting all remaining assets of the third investment pool into the sixth investment pool.

11. A method for allocating assets of a portfolio, which comprises the steps of:
investing the assets in a multiplicity of investment pools each having different assumed average rates of return and each having greater and greater time horizons;
designating a first investment pool of the investment pools to have an assumed average first rate of return being a lowest rate of return of all the investment pools and from which distributions are first withdrawn from, as needed, before withdrawing funds from any of the other investment pools; and
converting at least part of the assets of a second investment pool having an assumed average second rate of return being a next lowest rate of return into a new investment pool when the first investment pool is exhausted due to distributions, the assets of the new investment pool being invested at a same assumed average rate of return as the first investment pool and being available for distribution.

12. The method according to claim 11, which further comprises designating the distributions to be a combination of income and return of principle.

13. A method for allocating assets of a portfolio, which comprises the steps of:
investing a first portion of the assets in a first investment pool at an assumed average first rate of return;
investing a second portion of the assets in a second investment pool at an assumed average second rate of return being greater than the assumed average first rate of return;
investing a third portion of the assets in a third investment pool at an assumed average third rate of return being greater than the assumed average second rate of return;
investing a fourth portion of the assets in a fourth investment pool at an assumed average fourth rate of return being greater than the assumed average third rate of return;
investing a fifth portion of the assets in a fifth investment pool at an assumed average fifth rate of return being greater than the assumed average fourth rate of return;
investing a sixth portion of the assets in a sixth investment pool at an assumed average sixth rate of return being greater than the assumed average fifth rate of return; and
designating the first investment pool to be a pool from which assets may be distributed from until the first investment pool is exhausted.

14. The method according to claim 13, which further comprises:
converting assets of the second investment pool into a seventh investment pool having the assumed average first rate of return when the first investment pool is exhausted due to distributions; and
distributing the assets from the seventh investment pool when the assets in the first investment pool are exhausted.

15. The method according to claim 14, which further comprises:
bifurcating assets of the third investment pool into an eighth investment pool having the assumed average first rate of return and a ninth investment pool having the assumed average second rate of return when the seventh investment pool is exhausted; and
distributing the assets from the eighth investment pool as needed.

16. The method according to claim 15, which further comprises:
converting assets of the ninth investment pool into a tenth investment pool having the assumed average first rate of return when the eighth investment pool is exhausted; and
distributing the assets from the tenth investment pool as needed.

17. The method according to claim 16, which further comprises:
bifurcating assets of the fourth investment pool into an eleventh investment pool having the assumed average first rate of return and a twelfth investment pool having the assumed average second rate of return when the tenth investment pool is exhausted; and
distributing the assets from the eleventh investment pool as needed.

18. The method according to claim 17, which further comprises:
converting the assets of the twelfth investment pool into a thirteenth investment pool having the assumed average first rate of return when the eleventh investment pool is exhausted; and
distributing the assets from the thirteenth investment pool as needed.

19. The method according to claim 18, which further comprises:
converting the assets of the fifth investment pool into three new investment pools, including a fourteenth investment pool having the assumed average first rate of return, a fifteenth investment pool having the assumed average second rate of return, and a sixteenth investment pool having the assumed average third rate of return, when the thirteenth investment pool is exhausted; and
distributing the assets from the fourteenth investment pool as needed.

20. The method according to claim 19, which further comprises:
converting assets of the fifteenth investment pool into a seventeenth investment pool having the assumed average first rate of return when the fourteenth investment pool is exhausted; and
distributing the assets from the seventeenth investment pool as needed.

21. The method according to claim 20, which further comprises:
converting the assets of the sixteenth investment pool into an eighteenth investment pool having the assumed average first rate of return when the seventeenth investment pool is exhausted; and
distributing assets from the eighteenth investment pool as needed.

22. The method according to claim 13, which further comprises distributing the assets only from the first investment pool until the first investment pool is exhausted.

23. The method according to claim 13, which further comprises designating the distributions to be a combination of income and return of principle.

24. The method according to claim 13, which further comprises distributing the assets weekly, monthly, yearly, or as desired.

25. The method according to claim 13, which further comprises periodically reviewing a value of each of the investment pools and rebalancing values of all the investment pools as needed.

26. The method according to claim 13, which further comprises investing the assets in each subsequent investment pool for a longer time period than a previous investment pool where the assets of the sixth investment pools are invested for a longest time period and the assets of the first investment pool are invested for the. shortest period of time.

27. The method according to claim 1, which further comprises investing the assets in each subsequent investment pool for a longer time period than a previous investment pool where the assets of the third investment pools are invested for a longest time period and the assets of the first investment pool are invested for the shortest period of time.
